(19) United States
(12) Patent Application Publication
(10) Pub. No.: US 2015/0186997 A1
(43) Pub. Date: Jul. 2, 2015

(54) Methods, Systems and Apparatus to Provide a Compact Display of Inside Market Data

(71) Applicant: TRADING TECHNOLOGIES INTERNATIONAL, INC., Chicago, IL (US)

(72) Inventor: Scott F. Singer, Green Oaks, IL (US)

(73) Assignee: TRADING TECHNOLOGIES INTERNATIONAL, INC., Chicago, IL (US)

(21) Appl. No.: 14/142,836

(22) Filed: Dec. 28, 2013

(51) Int. Cl. G06Q 40/04; G06T 11/20; G06T 3/40

(52) U.S. Cl. CPC G06Q 40/04; G06T 11/206; G06T 3/40

(57) ABSTRACT

Methods and systems to facilitate display of market data and trading with respect to the market data on a trading device having reduced area for display are disclosed herein. An example method includes determining an available display area on a computing device, the computing device to receive a market data feed. The example method includes resizing a trading interface for display via the computing device based on the available display area. The example method includes processing the received market data feed for display via the trading interface based on the available display area. The example method includes displaying inside market data from the market data feed via the trading interface in the available display area of the computing device. The example method includes facilitating a trade based on selection of a bid or an ask from the inside market data via the trading interface.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

The trading device may provide a trading interface to enable a user to monitor the information about the market and execute trades via the electronic exchange. Some trading interfaces list prices, bid quantities and/or ask quantities of a tradeable object to enable the user to determine a market depth of the tradeable object.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a flow diagram representative of example machine readable instructions that may be executed to implement disclosed embodiments.

FIGS. 5a-d illustrate an example reduced-size trading interface in accordance with disclosed embodiments.

FIGS. 6a-d illustrate an example reduced-size trading interface in accordance with disclosed embodiments.

FIG. 7 illustrates a block diagram of an example system that may be employed with certain disclosed embodiments.

FIGS. 8a and 8b illustrate example devices configured to display reduced-size trading interface(s) in accordance with disclosed embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates generally to electronic trading environments and, more particularly, to methods, systems, and apparatus to provide compact, dynamic display of inside market information on a handheld or other mobile device.

Many different exchanges support electronic trading. Electronic trading allows a trader or trading application to interact with the exchanges from a remote location. Once connected to an exchange, the trader or trading application may receive market information about tradeable objects that are traded on the exchange. Market information may include bid prices, bid quantities, ask prices, ask quantities, prices and quantities for past sales, and/or other market related information, for example. The trader or trading application may additionally trade the tradeable objects, such as by entering buy or sell orders.

A trading device may implement a trading interface and/or trading window to allow interaction with one or more markets. For example, a trading interface may allow a user (e.g., a trader) to obtain and view market data, set order entry parameters, submit order messages to an exchange, deploy trading algorithms, and/or monitor positions while implementing various trading strategies. A trading interface may provide, for example, a market depth ladder or market grid showing quantities available at an inside market and at other prices away from the inside market. Often, a plurality of trading interfaces are implemented at the trading device, and the user selects between the plurality of trading interfaces to interact with the market associated with the selected trading interface. A trading interface may include one or more trading windows, for example.

In general, users desire to be able to react more quickly than other market participants. For example, market participants (or traders or other users) generally desire to be “first-to-market” (e.g., have orders entered prior to other market participants entering the same or similar orders). It is therefore advantageous to optimize the manner in which market data is displayed to the user and to allow the user to make fast and accurate order entry. The slightest speed advantage may give a user a significant competitive advantage.

Trading applications allow users to at least evaluate market data and/or initiate one or more trade actions based on that market data. A trade action may, for example, include a command or communication to initiate a sell order, initiate a buy order, and/or request a modification or cancelation of an existing order. In some examples, a trading application may include a trading interface having one or more trading windows to display market data or a portion of the market data. In addition, the trading windows may include trade action controls to initiate or execute trade actions. A trade action control is a button, cell, or area on a trading screen that corresponds to a particular trade action. In some examples, when the trade action control is enabled, the trading device may execute or perform the corresponding trade action, such as placing, cancelling or changing a trade order.

Display device such as touch screens allow users to directly or indirectly interact with the trading application on a device, such as a handheld or other mobile device. In some examples, a user operates (e.g., executes) the trading application by directly interacting with the components displayed via the touch screen on the mobile device. For example, a user may initiate sending or execution of a trade action (e.g., communicate a sell order, a buy order, etc.) by directly selecting a trade action control (e.g., a button) corresponding to the trade action displayed on a smartphone or tablet computer. As a result, trade actions may be executed more efficiently by the user.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Methods and systems to facilitate display of market data and trading with respect to the market data on a trading device having reduced area for display are disclosed herein.

Certain embodiments provide a method including determining an available display area on a mobile computing device, the mobile computing device configured to receive a market data feed. The example method includes resizing a trading interface having multiple rows for display via the computing device based on the available display area and at least one display rule applied to one or more rows of the trading interface. The example method includes processing the received market data feed for display via the trading interface based on the available display area and the at least one display rule. The example method includes displaying inside market data from the market data feed via the trading interface in the available display area of the computing device, wherein the received market data is displayed according to the at least one display rule. The example method includes facilitating a trade based on selection of a bid or an ask from the inside market data via the trading interface.

Certain embodiments provide a tangible computer readable storage medium including computer program code to be executed by a computing device. The example computer program code, when executed, is to implement a method. The example method includes determining an available display area on a computing device, the computing device to receive a market data feed. The example method includes resizing a trading interface for display via the computing device based on the available display area. The example method includes processing the received market data feed for display via the trading interface based on the available display area. The example method includes displaying inside market data from the market data feed via the trading interface in the available display area of the computing device. The example method includes facilitating a trade based on selection of a bid or an ask from the inside market data via the trading interface.

Certain embodiments provide a system including a computing device. The example computing device is configured to determine an available display area on the computing device, the computing device to receive a market data feed. The example computing device is configured to resize a trading interface for display via the computing device based on the available display area. The example computing device is configured to process the received market data feed for display via the trading interface based on the available display area. The example computing device is configured to display inside market data from the market data feed via the trading interface in the available display area of the computing device. The example computing device is configured to facilitate a trade based on selection of a bid or an ask from the inside market data via the trading interface.

### II. Example Electronic Trading System

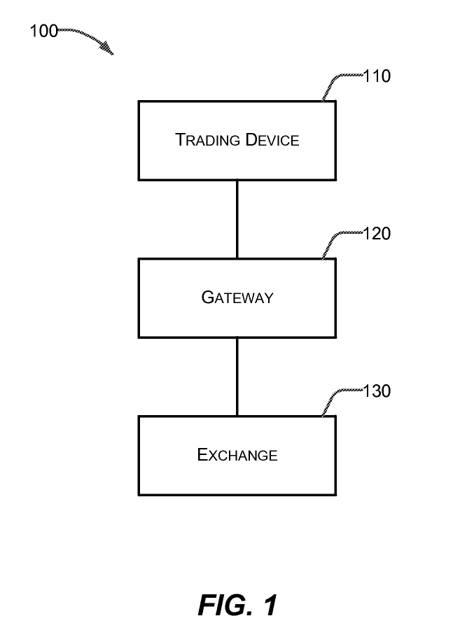

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. Due to the quantity available, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 may include a desktop computer, hand-held or other mobile device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order, etc. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium (or computer readable storage medium) may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a user may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

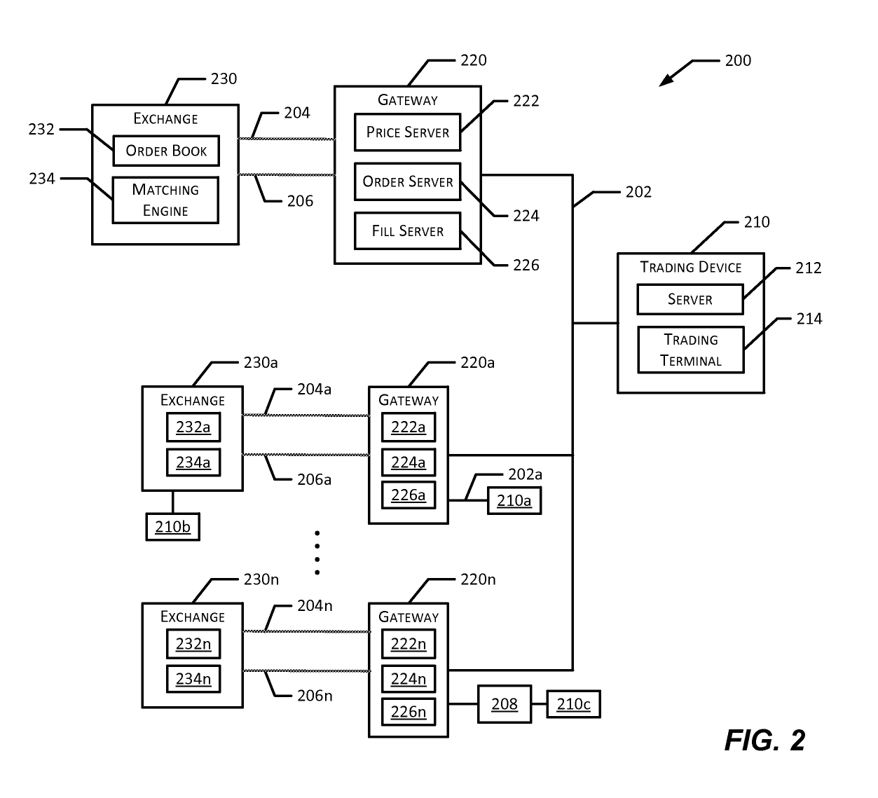

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

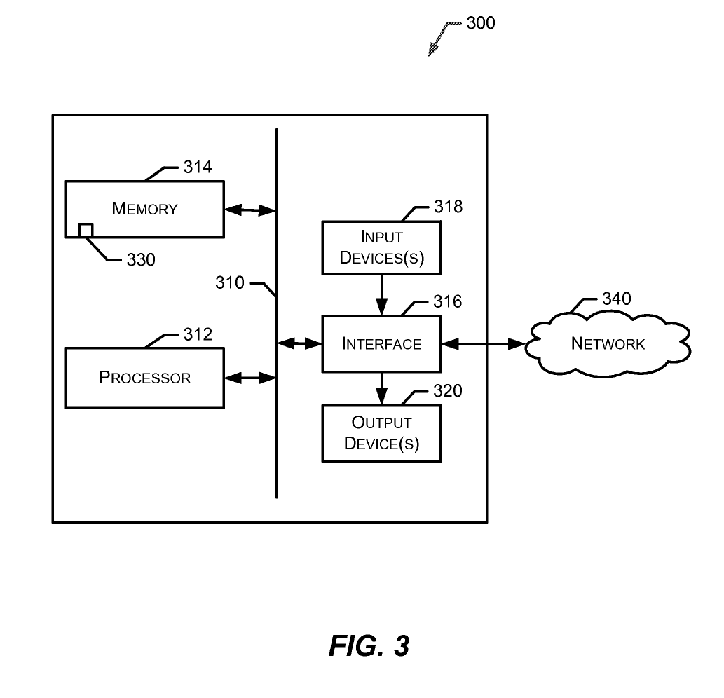

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 and/or output device 320. The computing device 300 may include and/or be implemented a computer, a handheld or other mobile device (e.g., smartphone, tablet, laptop, etc.), and so on, for example.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Compact Display of Inside Market

In certain examples, a trading interface is provided by a trading device to enable a user to monitor market data related to a tradeable object, execute trades of the tradeable object and/or perform other actions. In some examples, prices of the tradeable object, ask quantities, bid quantities and/or other information are displayed on the interface to enable the user to view a market depth of the tradeable object (e.g., bids to buy the tradeable object, offers to sell the tradeable object, etc.). A bid quantity is a given quantity of the tradeable object in a bid to buy the tradeable object at a given price. An ask quantity is a given quantity of the tradeable object in an offer to sell the tradeable object at a given price. As the tradeable object is traded on the market, the market depth of the tradeable object may change. A price of the tradeable object may increase, decrease, fluctuate or be substantially constant while the volume of trades of the tradeable object increases, decreases, fluctuates, or is substantially constant. A relationship between the price and the volume of the tradeable object may influence whether the user executes a trade. For example, if the user detects that the price and the volume of trades are decreasing, the user may go long. Such input and output is accepted and provided via the trading interface on the trading device, for example.

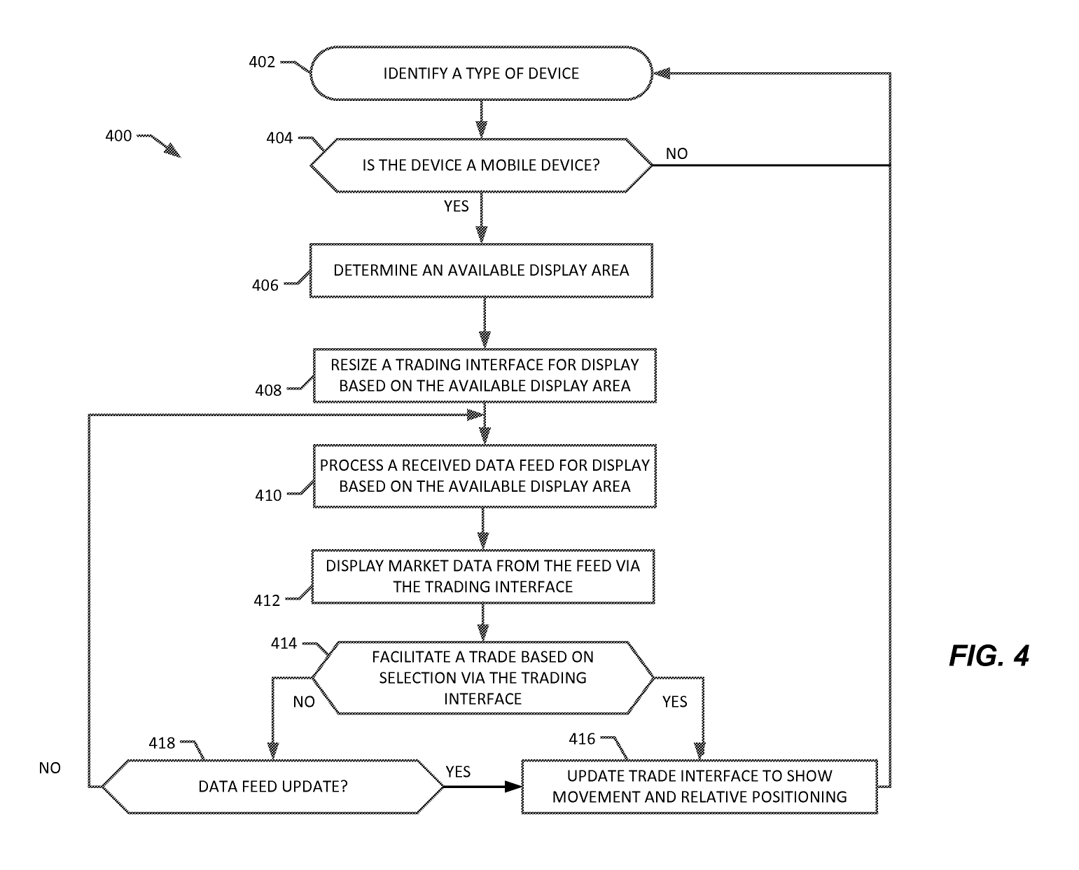

FIG. 4 is a flow diagram representative of a method 400 and example operations that can be executed to implement the teachings of this disclosure. The example operations of FIG. 4 can be implemented by, for example, the example trading device 110 of FIG. 1 and/or the example trading device 210 of FIG. 2. While the example trading device 110 of FIG. 1 is described as executing the example operations of FIG. 4 below, any suitable device can execute the method 400 and examples operations discussed in connection with FIG. 4.

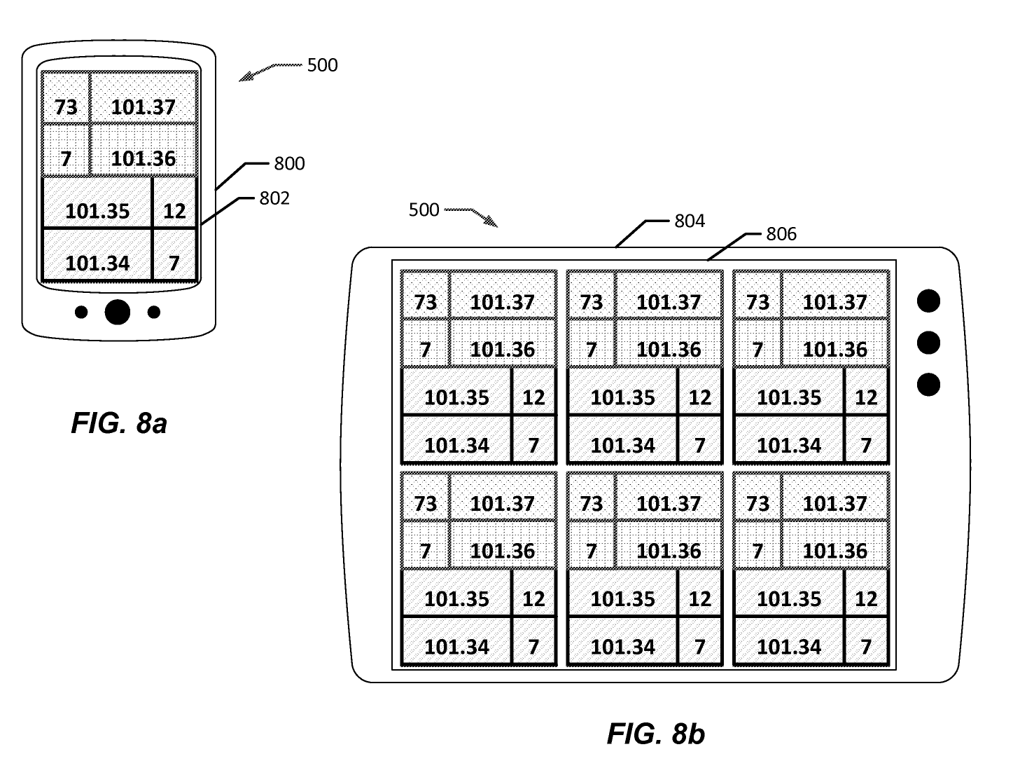

At block 402, a type of device displaying a trading interface is identified. For example, a trading device (e.g., trading device 110, 210, and the like) receiving a market data feed is identified. In certain embodiments, the identified device may be a person digital assistant (PDA) and/or a smartphone such as the device 800 shown in FIG. 8a, or tablet device such as the device 804 shown in FIG. 8b. The device can be identified, for example, using a first identifier associated with one or more of the device, a browser or other interface on the device, a trading program associated with the device, etc.

At block 404, it is determined whether the identified device is a handheld or mobile device. That is, it is determined whether the identified device is a device having a limited display area compared to a traditional trading interface display such as a display for a desktop or laptop computer. Based on the retrieved first identifier associated with the device, a trading program can determine whether the first identifier indicates and/or is associated with a smartphone such as the device 800 or a tablet device such as the device 804 having a limited display area.

At block 406, if the device is mobile device, an available display area is determined for the display device associated with the mobile device. For example, a second identifier may be used to indicate an available display area for the identified device. The second identifier may be associated with a trading interface, web browser, or other viewer used on the device, for example. In some examples, the second identifier may be the same as the first identifier. That is, the first identifier may both identify the device and the device's associated display area. In some examples, the second identifier may be different from the first identifier and may indicate a variable display area that may change between same-type devices depending upon user configuration, other program(s) running, etc. The example device 800 shown in FIG. 8a may be a smartphone including a display device 802. The display device 802 may have a display area and resolution of, for example, 1136×640 pixels and 326 pixels-per-inch (ppi). In this configuration, the display device 802 may measure 3.48 inches by 1.96 inches and result in a display area measuring 4 inches diagonally. In another example, the device 804 shown in FIG. 8b may be a tablet device including a display device or display 806. The display device 806 may have a display area and resolution of, for example, 2048×1536 pixels and 264 pixels-per-inch (ppi). In this configuration, the display 806 may measure 7.76 inches by 5.82 inches and result in a display area measuring 9.7 inches diagonally. In certain embodiments, the example device 800 may be an IPHONE® and the example device 804 may be IPAD AIR™ both sold by APPLE® of Cupertino, Calif.

At block 408, a trading interface is resized for presentation via the display device portion of the mobile device based on the available display area. For example, a trading interface is launched on the mobile device and determines an appropriate size for display based on the available display area. Rather than simply replicating the same display elements utilized with a full-size display coupled to a desktop or laptop computer, a reduced-size trading interface display is generated for the mobile or other handheld device (e.g., a smartphone, tablet computer, etc.). The reduced-size trading interface display can be a miniaturized display of a trading interface (e.g., a trading interface such as the interface shown and described in U.S. Pat. No. 6,772,132, co-assigned with the present patent to Trading Technologies, which is herein incorporated by reference in its entirety). Alternatively or in addition, the reduced-size trading interface can display a reduced amount of information on the mobile device screen.

For example, the reduced-size trading interface shows a degree of market depth (e.g., the inside market, inside market plus one or more additional bid/ask, etc.). A user can execute a trade with a single “click” or other selection of an item in the reduced-size trading interface. In some examples, a three-row trading interface is provided. An example three-row trading interface includes a display of a best bid, best ask, and last traded information. In some examples, a four-row trading interface is provided. An example four-row trading interface includes a display of a best bid, best ask, and last traded information, along with additional information, such as an additional level of market depth. In some examples, multiple reduced-size trading interfaces can be arranged on a device (e.g., three, four, six, etc., reduced-size trading interfaces can be arranged across a tablet computer screen, and so on). In some examples, a trading interface screen can be manipulated by a user to expand from a three-row trading interface to a four-row trading interface, and so on.

At block 410, a received data feed is processed for display based on the available display area. For example, an exchange sends price, order, and fill information to the mobile trading device for display via the reduced-size trading interface. If multiple reduced-size trading interfaces are provided, data from multiple exchanges and/or multiple tradeable objects can be displayed, for example. The mobile trading device processes the received data to map the data to positions in a grid, ladder, and/or other graphical representation for display. In some examples, an amount of data provided is limited by an amount of data provided to the device from the exchange. In some examples, an amount of data provided is limited by the available display area of the mobile device.

In some examples, a feed specific to a reduced-size trading interface on a mobile device may be provided. A specific feed may be limited to inside market data, inside market data plus one or two layers of additional market depth, etc. A specialized feed including only data for the reduced-size display may be provided to support mobile trading devices on an unreliable network, for example. In some examples, a regular market data streaming feed may be provided, and the mobile trading device is relied upon to process the data stream and decide what is to be used for the reduced-size display.

Market data may be provided in a data stream, in a frame-by-frame sequence of data, etc. In some examples, market data can be sent as an image that is refreshed (e.g., based on a timer, via a pull for market data, via a push of market data, on demand by a user, etc.) for display. In some examples, an intermediary can format data for display by the interface on the mobile device. In some examples, the market data feed is refreshed at a same rate as a traditional trading device. In some examples, if the mobile trading device is on a wireless data plan, market data refresh may result from user request, at a lower rate, etc.

At block 412, market data such as inside market data from the data feed is displayed via the trading interface on the mobile device. The market data utilized by the trading interface on the mobile device may be limited to inside market data, market data within a specified number of ticks away from the inside market or any other desired level of market depth. For example, the inside market and/or other market depth data extracted from an exchange data feed, reduced bandwidth data feed, market data snapshot or image, etc., is displayed via one or more reduced-size trading interfaces on the mobile device. Market data is displayed for trader review and interaction via the mobile device.

At block 414, a trade can be facilitated based on a selection of an item via the trading interface. For example, the reduced-size trading interface can be arranged similar to the MD TRADER® trading interface provided by Trading Technologies to provide a price column, a buy column, and a sell column, where a user can click on or otherwise select a bid or ask in a buy or sell column. On the reduced-size trading interface displayed via the mobile trading device, a user clicks to buy or sell at a given level. The trade request or other trade information is routed to a gateway and/or exchange via a communication interface of the trading device, for example.

At block 418, if no trade is to be facilitated, then the device checks for a data feed update. As discussed above, market data can be pushed to the trading device, pulled by the trading device, sent in a traditional data feed, sent in a custom data feed, sent as a data image for display, etc. If a data feed update is available, then at block 416, the trading interface is updated to show movement and relative positioning. Based on a trade and/or other market data update, the reduced-size interface is updated for display via the mobile device. The process 400 can then restart by identifying the type of device to display the trading interface. However, if a data feed update is not available at block 418, then the process 400 can return to block 410 to display the current trade and/or other market data.

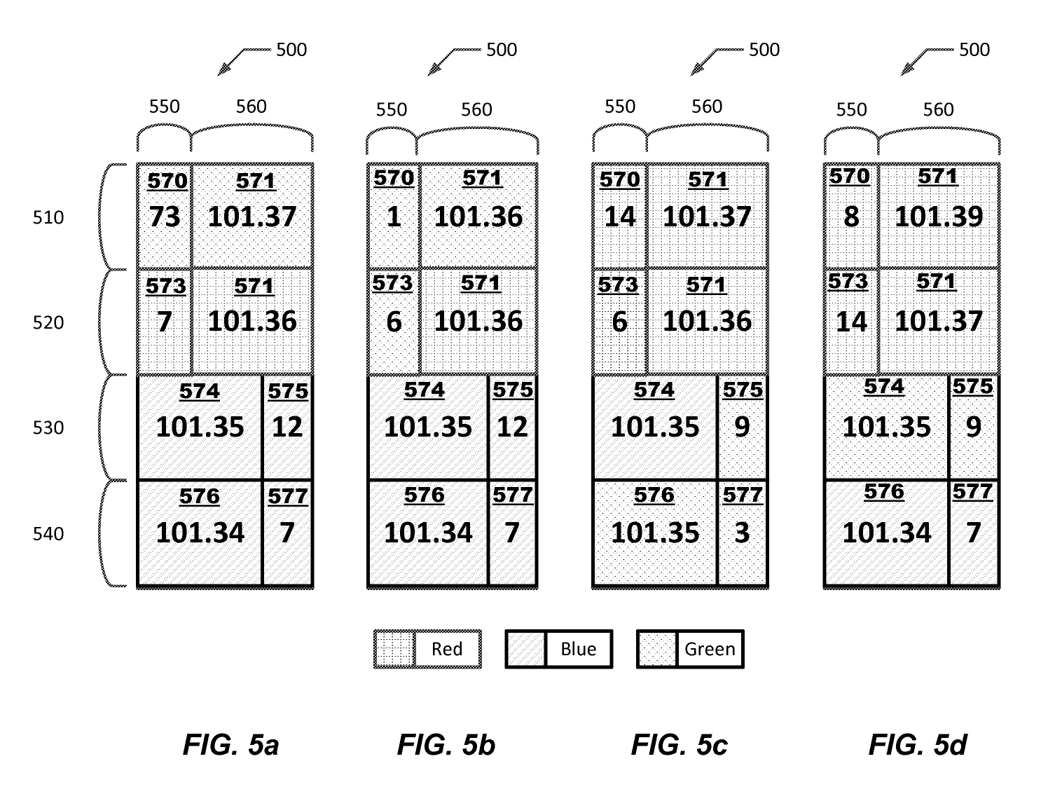

FIGS. 5a-d illustrate an example reduced-size trading window or interface 500 disclosed herein. While the following examples are described in conjunction with the example trading device 210 of FIG. 2 and the example electronic trading system 200 of FIG. 2, the examples disclosed herein may be implemented using any trading device in any other electronic trading system such as the example trading device 110 of FIG. 1.

As described above in conjunction with FIG. 2, the example trading device 210 receives market data related to one or more tradeable objects from the exchange 230 and/or the exchange 230 through the gateway 220. The example trading device 210 displays, and may locally execute, a trading application providing a trading tool to process and/or organize the market data and provide the example trading interface 500 of FIG. 5. The example trading tool may be, for example, MD_TRADER®, X_TRADER®, one or more of the trading tools described in U.S. Pat. No. 6,772,132, filed on Jun. 9, 2000, which is hereby incorporated herein by reference in its entirety, and/or any other trading tool. The example trading device 210 displays the interface 500 to enable a user to view the market data and execute trades via the electronic exchange 230 and/or the other electronic exchanges 230a-230n.

The example trading interface 500 may be configured to efficiently display bid and ask data regardless of the number of rows of market depth presented. For example, each row of the trading interface 500 may be configured, based on display rules, to include a cell sized to display prices as a percentage of the total row width and another cell sized to display quantity as the remaining percentage of the total row width. FIG. 8a illustrates one example of the trading interface 500 configured for presentation on the display 802 of the device 800. FIG. 8b illustrates another example of an array of trading interfaces 500 configured for presentation on the display 806 of the device 804. Each of the individual trading interfaces 500 displayed in the array can be configured to display and/or present market data related to unique or specific tradeable object.

Display rules can be as simple as each row includes price/quantity cells arranged in a cell ratio characterized by and an m:n ratio. For example, a cell ratio may be a 1:1 ratio that specifies that reach row be divided into equally sized cells (i.e., each call is 50% of the total row length). Other cell ratios may be, for example, a 6:4 cell ratio or a 7:3 cell ratio. For example, applying a display rule that include a 7:3 cell ratio to the device 800 shown in FIG. 8a results in a trading interface 500 having four (4) rows that are 284 pixels high and two (2) columns that are 448 pixels and 192 pixels wide, respectively. Since the numbers involved can be large, even for quantity, the display rules need to be flexible and/or variable to ensure the information can be properly displayed. One variation of display is to have the bid rows arranged where the prices are arranged in the leftmost column while quantities on arranged in the rightmost column of the same row. The offer or ask rows may be arranged with the prices in the rightmost column and quantities in the leftmost column. In this example arrangement the cells that display prices could be slightly wider than the cells that display quantities. In this way, the columns within trading interface 500 need not be uniform from the top to the bottom of the window. In certain embodiments, display rules may be implemented in conjunction with an array of trading interfaces 500. For example, applying a display rule that include a 7:3 cell ratio to the device 804 shown in FIG. 8b results in a three (3) by two (2) array of trading interfaces 500. In this example, each of the arrayed trading interfaces 500 includes four (4) rows that are 192 pixels high, e.g., row height=(1536 pixels/(4 rows×2) and two (2) columns that are 478 pixels, e.g., first column width=(2048 pixels/3 arrayed)×0.7, and 204 pixels (2048 pixels/3 arrayed)×0.3), wide, respectively. The size of the rows, columns as well as the individual display rule may be adjusted based on the resolution of the display device. The configuration of the trading interface 500 may be further adjusted

In certain embodiment, the trading interface 500 may employ rules for coloring each of the rows and/or cells displaying pricing and quantity information. For example, when only bid and ask rows are displayed and no LTP/LTQ information is shown, the trading interface 500 can employ a color coding that colors the backgrounds of the cells similar to MD_TRADER with blue and red background colors. In certain embodiments a color coding can include LTP and/or LTQ information, such that an entire row corresponding to the LTP can be colored green, for example, in place of the bid/ask coloring that would typically be applied. The coloring rules contained within the color coding applied in this manner provide an indication of where the LTP was, and the left/right arrangement of bid/ask rows (with the example 60/40 sizing) allows the user to know that the LTP was on the bid or the offer, as well as if it was on a price level that is no longer best bid/offer.

In the illustrated example, the reduced-size trading interface 500 includes a plurality of rows including a first row 510, a second row 520, a third row 530, and a fourth row 540. The example reduced-size trading interface 500 of FIGS. 5a-d also includes a plurality of columns 550, 560. The example columns 550, 560 and the example rows 510, 520, 530, 540 intersect to define a plurality of blocks 570-577. In the illustrated example 500 of FIG. 5a, blocks 570 and 572 indicate ask quantities of a tradeable object, and blocks 571 and 573 indicate associated ask prices. Blocks 575 and 577 represent bid quantities of the tradeable object, and blocks 574 and 576 indicate associated bid prices. The bid quantity is a given quantity of the tradeable object in a bid to buy the tradeable object at a given price. The ask quantity is a given quantity of the tradeable object in an offer to sell the tradeable object at a given price. In other examples, the bid quantities, ask quantities and/or prices are displayed in other orientations and/or via other organizational structures. In certain embodiments, the second row 520 and the third row 530 are arranged to display quantities at the prices defining the inside market. In other embodiments, the prices may be replaced with derivatives of price, price deltas, consolidated price levels or other representations of relative value.

In the illustrated example, the blocks 570-577 are updated (e.g., substantially continuously or periodically based on available communication bandwidth) to indicate a market depth of the tradeable object. For example, values of the ask quantities and/or the bid quantities are updated (e.g., increased or decreased) based on the market data (e.g., bids to buy and/or the offers to sell the tradeable object). In some examples, new and/or additional bid quantities and/or ask quantities are included in response to a change (e.g., an increase) in the market depth of the tradeable object (e.g., a new offer to sell, a new bid to buy, etc.). In some examples, bid quantities and/or ask quantities are updated or removed in response to a change (e.g., a decrease) in the market depth of the tradeable object (e.g., when a trade is completed). The example trading interface 500 enables the user to execute trades of the tradeable object via the electronic exchange 230. In the illustrated example, a user can select a quantity at a certain price via the trading interface 500 to facilitate an associated trade.

In the illustrated example of FIG. 5a, the first row 510 shows a last traded price 571 and an associated last traded quantity 570. The second row 520 shows an ask quantity 572 and an ask price 573. In the illustrated example, the last traded price 571 is higher price and is therefore aligned above the current ask price 573. The example trading interface 500 further illustrates that a quantity of one is traded at a price of 101.36 (shown in FIG. 5b in the first row 510 updating a quantity 570 and an associated price 571). As a result the quantity 572 is reduced by one to reflect that a trade has occurred. Now, as shown in the example interface 500 of FIG. 5b, the last traded price 571 is at the ask price 573. Next, as illustrated in the example of FIG. 5c, a quantity of three is traded at a price of 101.35 (shown at blocks 576 and 577 of FIG. 5c), which is a current bid 574, reducing the bid quantity 575 from twelve (as shown in the example of FIG. 5b) to nine (as shown in the example of FIG. 5c). The quantity of three shown in the block 577 represents the last traded quantity while the last traded price of 101.35 is shown in 576. The last traded price, in the illustrated example, is 101.35 which is also the current bid price as shown in block 574.

As shown in the example of FIG. 5d, the offer at 101.36 (row 520 in FIG. 5c) has been pulled, and the bid of nine at 101.35 (row 530 in FIG. 5c) has been fully filled. Because the last trade was on the bid, the row 530 shows the quantity 575 on the right side 560 of the example interface 500. If the trade had been on the offer, the quantity would have been on the left side 550 of the interface 500.

As shown in the example interface 500 of FIGS. 5a-d, the fourth row 540 allows the row position of the best bid and ask not to change unless the last traded price is on a price that is between the best bid and best ask. As used for purposes of example illustration only, red (depicted as a cross hatch pattern) in the example indicates an ask quantity and price, and blue (depicted as a slanted line pattern) indicates a bid quantity and ask. Similarly, green (depicted as a pattern of closely spaced dots) may be used to indicate that an entire row or a column within a given row corresponds to the LTP.

As shown in the examples of FIGS. 5a-d, a box 570-577 stays green when the block (e.g., the quantity and/or price) is still the last place where a trade occurred. That is, a block 570-577 stays green for as long as the trading state stays the same. A green block or segment 570-577 of the example reduced-size trading interface 500 indicates that there was a trade at the indicated price level, and no change has occurred in what was offered at that price level in the market since that trade.

In some examples, a block 570-577 may flash green at the moment of a trade, but the green is replaced by blue or red because a quantity has been added, another trade occurs, etc. Flashing may help to visually indicate an active trading market, for example.

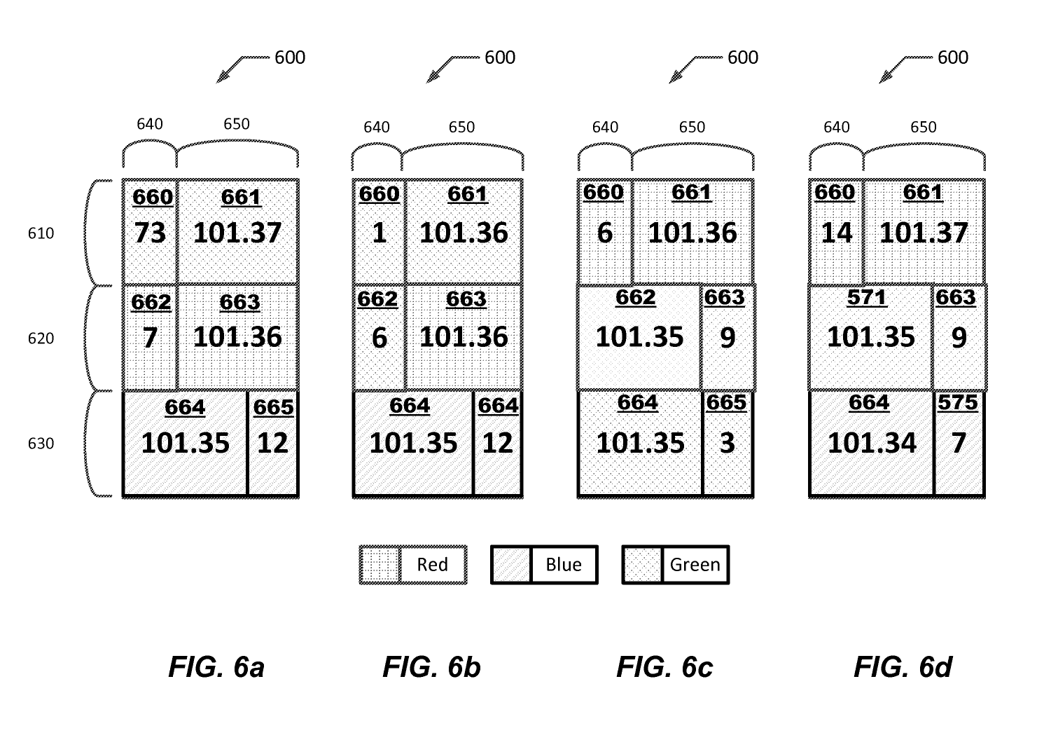

FIGS. 6a-d illustrate an example reduced-size interface 600 having three rows instead of four rows (as illustrated in the examples of FIGS. 5a-d). The interface 600 functions similarly to the interface 500, for example. In the illustrated example, the reduced-size trading interface 600 includes a plurality of rows including a first row 610, a second row 620, and a third row 630. The example reduced-size trading interface 600 of FIGS. 6a-d also includes a plurality of columns 640, 650. The example columns 640, 650 and the example rows 610, 620, 630 intersect to define a plurality of blocks 660-665. In the illustrated example 600 of FIG. 6a, blocks 660 and 661 indicate last traded quantity and last traded price, respectively, for a tradeable object. Blocks 662 and 663 indicate ask quantity and ask price, respectively, for the tradeable object. Blocks 664 and 665 represent a bid price and a bid quantity, respectively, for the tradeable object. In this way, the second row 620 and the third row 630 cooperate to display the quantities at the prices defining the inside market.

As illustrated in the example of FIG. 6a, the last traded price 661 is above the ask price 663. A quantity of one trades at a price of 101.36, which is on the current offer in row 620. As shown in the example of FIG. 6b, the last traded price 661 is now at the ask 663. Then a quantity of three is traded at a price of 101.35, which is the current bid 664. As illustrated in the example of FIG. 6c, the last traded price 662 is now at the bid 664.

Then, as shown in the example of FIG. 6d, the offer at 101.36 (row 610 in FIG. 6c) was pulled, and the bid nine at 101.35 (row 620 in FIG. 6c) was fully filled. Because the trade was on the bid, the row 620 shows the quantity on the right 650. If the trade had been on the offer, the row 620 would show the quantity on the left 640, for example.

As illustrated in the three-row reduced size interface 600, a last trade quantity row moves depending on whether it was on the bid or ask. In other embodiments, the last trade quantity row could be kept on top of the three-row reduced size interface 600 and highlighted green as the quantity of bid and ask trades are updated.

In some examples, the three-row reduced size interface 600 can be expanded by a user to become a four-row reduced size interface 500, or vice versa, depending upon available display area, number of reduced-size interface(s) desired, market volatility, user preference, etc. While three- and four-row interfaces have been shown and described as illustrative example, other numbers of rows and/or columns can be implemented in a reduced-size trading interface as well.

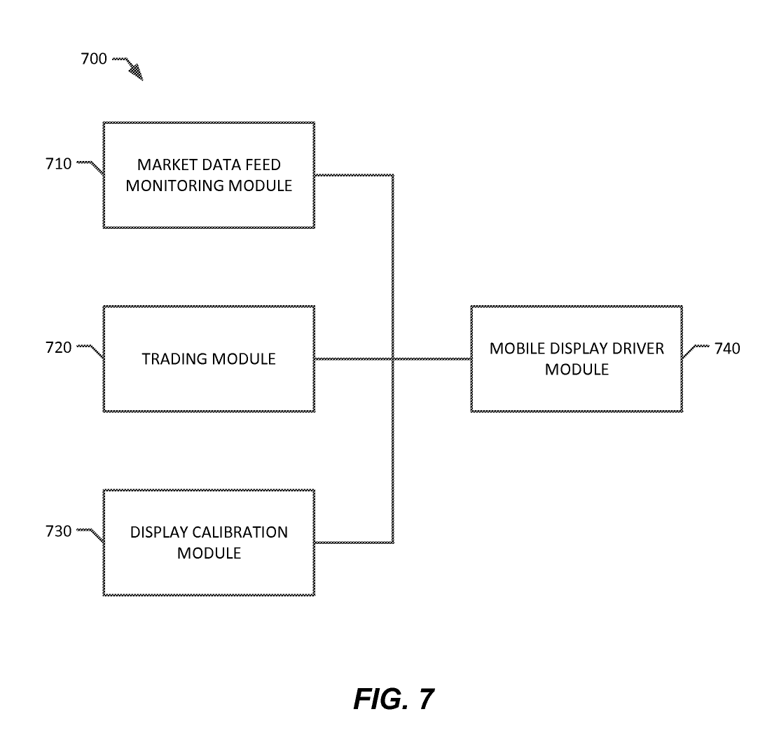

FIG. 7 is a block diagram of an example system 700 that may implement and/or execute the example operations of FIGS. 5-6. In some examples, the system 700 may be implemented as part of software (or an application) associated with the trading device 110 of FIG. 1, the gateway 120 of FIG. 1 and/or the electronic exchange 130 of FIG. 1. In some examples, the system 700 may be implemented as computer implemented code or instructions operable independent of software associated with the trading device 110 of FIG. 1, the gateway 120 of FIG. 2 and/or the electronic exchange 130 of FIG. 1. In some examples, the features and functionality of the system 700 may be implemented in hardware operable in connection with the trading device 110 of FIG. 1, the gateway 120 of FIG. 1 and/or the electronic exchange 130 of FIG. 1.

The example system 700 of FIG. 7 includes an example market data feed monitoring module 710, an example trading module 720, an example display calibration module 730, and an example mobile display driver module 740. In some examples, the market data feed monitoring module 710 receives market data. In some examples, the market data feed monitoring module 710 receives market data (e.g., inside market data) from, for example, the gateway 120 of FIG. 1, the electronic exchange 130 of FIG. 1 and/or an intermediary component. For example, market information updates may be communicated from the gateway 120 to the trading device 110. Based on the market data and/or available display area for an associated mobile device (e.g., a smartphone, tablet computer, other handheld trading device, etc.), the display calibration module 730 provides input to the mobile device display driver module 740 to generate one or more trading interfaces and provide market information via a mobile device display. For example, the received market data can be formatted according to a three- or four-row reduced size trading interface.

The example mobile display driver module 740 of the example system 700 renders the displayed user interface. For example, the mobile display driver module 740 generates a user interface including one or more trade action controls for a trading window. In addition, when market information is received via the market data feed monitoring module 710 and/or adjustments to interface display size are made by the display calibration module 730, the mobile display driver module 740 may update the relevant portions of the user interface.

The example trading module 720 of the system 700 receives input and facilitates trades via the reduced-size trading interface generated by the mobile display driver module 740. Resulting trades may impact the market and trigger updates to market data and the inside market. Updated information is then provided back to the system 700 via the market data feed monitoring module 710.

Thus, certain embodiments provide improved, flexible display of market data via a mobile or other device having reduced or limited display area compared to traditional trading interface screens. Certain embodiments help facilitate trading via a mobile device based on an improved, easy to read and easy to use trading interface. Certain embodiments provide an adaptive, scalable trading interface able to accommodate a variety of display sizes, bandwidths, and resource constraints.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
determining an available display area on a mobile computing device, the mobile computing device configured to receive a market data feed;
resizing a trading interface having multiple rows for display via the mobile computing device based on the available display area and at least one display rule applied to one or more rows of the trading interface;
processing the received market data feed for display via the trading interface based on the available display area and the at least one display rule;
displaying inside market data from the market data feed via the trading interface in the available display area of the mobile computing device, wherein the received market data is displayed according to the at least one display rule; and
facilitating a trade based on selection of a bid or an ask from the inside market data via the trading interface.

2. The method of claim 1, wherein the at least one display rule defines a color-coding configured to dynamically distinguish a last traded quantity, a bid quantity, and an ask quantity.

3. The method of claim 1, wherein the at least one display rule includes an m:n cell ratio.

4. The method of claim 3, wherein the cell ratio is selected from the group consisting of: a 1:1 cell ratio, a 6:4 cell ratio, and a 7:3 cell ratio.

5. The method of claim 1, further comprising updating the trading interface to show movement and relative positioning in an inside market.

6. The method of claim 1, wherein the trading interface having multiple rows includes a three row configuration and a four row configuration.

7. The method of claim 6, wherein the three row configuration includes a first row providing a highest bid price and an associated bid quantity, a second row providing a lowest ask price and an associated ask quantity, and a third row providing a last traded price and an associated last traded quantity.

8. The method of claim 7, wherein the four row configuration further includes a fourth row providing at least one of an additional a) bid price and associated bid quantity or b) ask price and associated ask quantity.

9. The method of claim 1, wherein the mobile computing device comprises a mobile device configured to display multiple instances of the trading interface arranged in an array.

10. The method of claim 1, wherein the market data feed includes at least one price defining the inside market data and at least one quantity associated with the at least one price.

11. The method of claim 10, wherein the market data feed further includes a last traded quantity.

12. The method of claim 11, wherein the last traded quantity includes a bid side last traded quantity and an ask side last traded quantity.
